(19) United States
(12) Patent Application Publication
(10) Pub. No.: US 2003/0179213 A1
(43) Pub. Date: Sep. 25, 2003

(54) Method for automatic retrieval of similar patterns in image databases

(76) Inventor: Jianfeng Liu, Shanghai (CN)

Correspondence Address: HARNESS, DICKEY & PIERCE, P.L.C., P.O. BOX 8910, RESTON, VA, 20195, US

(21) Appl. No.: 10/101,485

(22) Filed: Mar. 20, 2002

(30) Foreign Application Priority Data
Mar. 18, 2002 (CN) 02120598.1

(51) Int. Cl. G09G 5/00

(52) U.S. Cl. 345/619

(57) ABSTRACT

An image retrieval system and method that combines histogram-based features with Wavelet Frame decomposition features, as well as two-pass progressive retrieval process. The proposed invention is robust against illumination changes as well as geometric distortions. During the first round of retrieval, moment features of image histograms in the Karhunen-Loeve color space are derived and used to filter out most of the dissimilar images. During the second round of retrieval, multi-resolution WF decomposition is recursively applied to the remaining images. A set of coefficients of low-pass filtered subimages at the coarsest level, after being mean-subtracted and normalized, are utilized as features containing spatial-color information. Modulus and direction coefficients are calculated from the high-pass filtered X-Y directional subimages at each level, and central moments are derived from the direction histogram of the most significant direction coefficients to obtain TRSI direction/edge/shape features. Since the proposed invention is fast and robustness against illumination and geometric distortions, the invention is quite appealing for real-time image/video database indexing and retrieval applications.

### BACKGROUND OF THE INVENTION

1. Field of the Invention

The present invention relates generally to the retrieval of images from large databases, and more particularly, to a system and method for performing content-based image retrieval using both features derived from the color histogram of images and features derived from wavelet decomposition of images.

2. Description of the Related Art

With the recent advances in multimedia technology, enormous information is generated in the form of digital images and videos. Fast and accurate indexing and retrieval of such large image/video database based on content would, on the one hand, save the time and energy needed for extensive manual searching, and on the other hand, avoid the ambiguity and other weaknesses that the traditional key-word based indexing and retrieval methods have subsequently involved. Consequently, content-based indexing and retrieval of large image/video database has been the subject of much attention over the years.

For content-based image/video retrieval, such low-level features as color, texture, shape, edges have been separately proposed as a set of useful database feature index. Among these visual features, color is one of the most dominant and important features for image representation. With color histogram-based retrieval approaches, the retrieval results are not affected by variations in the translation, rotation and scale of images. Therefore, color histogram-based methods can be regarded as translation, rotation and scaling invariant (TRSI). It has been demonstrated by C. E. Jacobs et al. in the paper, “Fast Multiresolution Image Querying,” Proc. Of ACM SIGGRAPH Conference on Computer Graphics and Interactive Techniques, pp. 277-286, Los Angeles, August 1995, that histogram-based methods achieve superior retrieval performance in view of geometric distortions.

However, as further discussed by Jacobs et al., histogram based methods are sensitive to illumination changes. Meanwhile, as histogram-based methods provide no spatial distribution information and require additional storage space, false hits may frequently occur when the image database becomes too large.

Alternatively, wavelet-based indexing and retrieval methods are known in the art, which are invariant to illumination changes when suitably designed. Such methods are described in the Jacobs et al. paper, as well as an article by X. D. Wen et al. entitled “Wavelet-based Video Indexing and Querying,” Multimedia Systems, Vol. 7, No. 5, pp. 350-358, September 1999. However, these wavelet-based methods are not robust against image translation and rotation. In addition, the fundamental mathematical drawbacks of these methods make them incapable of effectively handling queries in which the image has frequent sharp changes.

As a matter of fact, few existing video/image retrieval methods can effectively take into account a variety of features including color, spatial distribution, and direction/edge/shape, while yielding good retrieval results especially when both illumination and geometric distortions occur.

Accordingly, it would be advantageous to provide an image retrieval approach based on color, spatial, and direction/edge/shape features, which achieves satisfactory retrieval performance despite differences in image translation, rotation, scaling and illumination.

### SUMMARY OF THE INVENTION

The present invention is directed towards fast and accurate image retrieval with robustness against image distortions, such as translation, rotation, scaling and illumination changes. The image retrieval of the present invention utilizes an effective combination of illumination invariant histogram features and translation invariant Wavelet Frame (WF) decomposition features.

The basic idea of the present invention is to retrieve images from the image database in two steps. In the first step, the illumination invariant moment features of the image histogram in the orthogonal Karhunen-Loeve (KL) color space are derived and computed. Based on the similarity of the moment features, images that are similar in color to the query image are returned as candidates. In the second and last step, to further refine the retrieval results, multi-resolution Wavelet Frame (WF) decomposition is recursively applied to both the query image and the candidate images. The low-pass subimage at the coarsest resolution is downsampled to its minimal size so as to retain the overall spatial-color information without redundancy. Spatial-color features are then obtained from each mean-subtracted and normalized coefficient of the low-pass subimage. Meanwhile, histograms of the directional information of the dominant high-pass coefficients at each decomposition level are calculated. Central moments of the histograms are derived and computed as the TRSI direction/edge/shape features. With suitable weighting, the above spatial and detailed direction/edge/shape features obtained from the WF decompositions are effectively combined with the color histogram moments calculated in the first step. Images are then finally retrieved based on the overall similarity of these features.

Impressive image retrieval results can be obtained due to the combination of color, spatial distribution and direction/edge/shape information derived by the present invention from both the illumination invariant histogram moments and spatial-frequency localized WF decompositions.

Advantages of the present invention will become more apparent from the detailed description given hereafter. However, it should be understood that the detailed description and specific examples, while indicating exemplary embodiments of the invention, are given by way of illustration only, since various changes and modification within the spirit and scope of the invention will become apparent to those skilled in the art from this detailed description.

### BRIEF DESCRIPTION OF THE DRAWINGS

The present invention will become more fully understood from the detailed description given below and the accompanying drawings, which are given for purposes of illustration only, and thus do not limit the present invention.

FIG. 1 is a block diagram of an image retrieval system according to an exemplary embodiment of the present invention.

FIG. 2 is a flowchart illustrating a method of retrieving images according to an exemplary embodiment of the present invention.

FIG. 3 is a flowchart illustrating a series of steps for determining candidate images that are sufficiently similar to a query image based on their color histogram features.

FIG. 4 is a flowchart illustrating a series of steps for determining the similarity of candidate images to a query image based on their spatial-color and direction/edge/shape features.

FIG. 5A illustrates the records of an image database in an exemplary embodiment where image features are determined and stored in the image database before an image query is submitted.

FIG. 5B illustrates the records of an image database and records of an image features database in an exemplary embodiment where image features are determined and stored in the image features database before an image query is submitted.

### DETAILED DESCRIPTION OF THE EXEMPLARY EMBODIMENTS

The present invention includes a system and method for performing content-based image retrieval according to two steps. In the first step, a set of candidate images whose color histogram is similar to a query image is determined. In the second step, the spatial-color features and the direction/edge/shape features of each candidate image is determined. The overall similarity of each candidate image is determined, using the determined color histogram, spatial-color, and direction/edge/shape features of each of the candidate images and the query image.

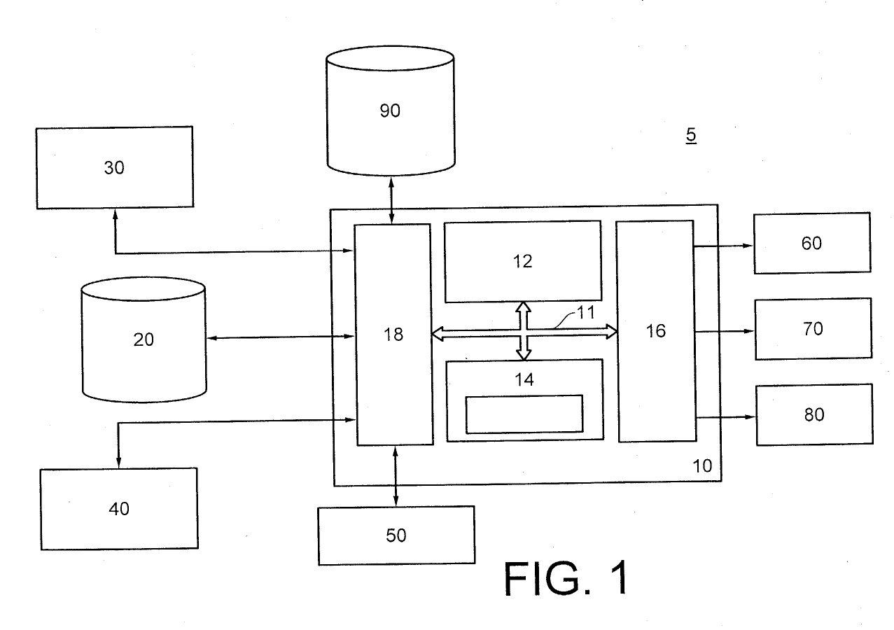

FIG. 1 is a block diagram of an image retrieval system 5 according to an exemplary embodiment of the present invention. The image retrieval system 5 includes an image similarity processing device 10 comprising a processor 12 connected to a memory 14, an output interface 16 and an input interface 18 via a system bus 11. The input interface 18 is connected to an image database 20, a query image input device 30, one or more user input devices 40, an external storage device 90 and a network 50. The output interface is connected to an image display 60, an image printer 70, and one or more other image output devices.

A user operates the image retrieval system 5 as follows. According to an exemplary embodiment, the user may either input a query image using the query image input device 30, or designate a query image using a user input device 40.

For example, the user may input a query image using a query image input device 30, which may include an image scanner, a video camera, or some other type of device capable of capturing a query image in electronic form. An application stored in memory 14 and executed by the processor 12, may include a user interface allowing the user to easily capture a query image using the query image input device 30 and perform an image retrieval on the image database 20 using the query image.

Alternatively, the application executed by processor 12 may provide a user interface, which allows the user to choose a query image from multiple images stored in memory 14 or external storage device 90 (e.g., a CD-ROM). The user may utilize a user input device 40, such as a mouse or keyboard, for designating the query image from the plurality of choices. Further, the application may allow the user to retrieve a query image from a server via network 50, for example, from an Internet site.

Once the query image is either chosen or input by the user, the processor 12 executes a content-based image retrieval algorithm to retrieve and output the most similar image or images from the image database 20. In an exemplary embodiment, the image database 20 may be stored in a storage device that is directly accessible by the image similarity processing device 10, such as a hard disk, a CD-ROM, a floppy disc, etc. Alternatively, the image database may be stored at a remote site, e.g., a server or Internet site, which is accessible to the image similarity processing device 10 via network 50.

Once the most similar image(s) are retrieved, they are output to the user through image display device 60 (e.g., computer monitor or a television screen), image printer 70, or another type of image output device 60. The other types of image output devices 60 may include a device for storing retrieved images on an external medium, such as a floppy disk, or a device for transmitting the retrieved images to another site via email, fax, etc.

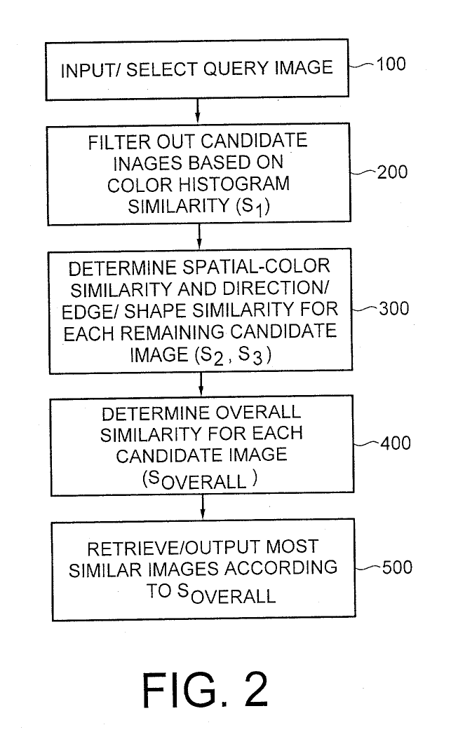

FIG. 2 is a flowchart illustrating the steps performed by the image similarity processing device 10 for retrieving images according to an exemplary embodiment of the present invention. It should be noted that while FIG. 1 illustrates an exemplary embodiment of the image retrieval system 5, the present invention is in no way limited by the components shown in FIG. 1. For instance, the image similarity processing device 10 may include any combination of software instructions executed by the processor 12 and specifically designed hardware circuits (not shown) for performing the steps disclosed in FIG. 2.

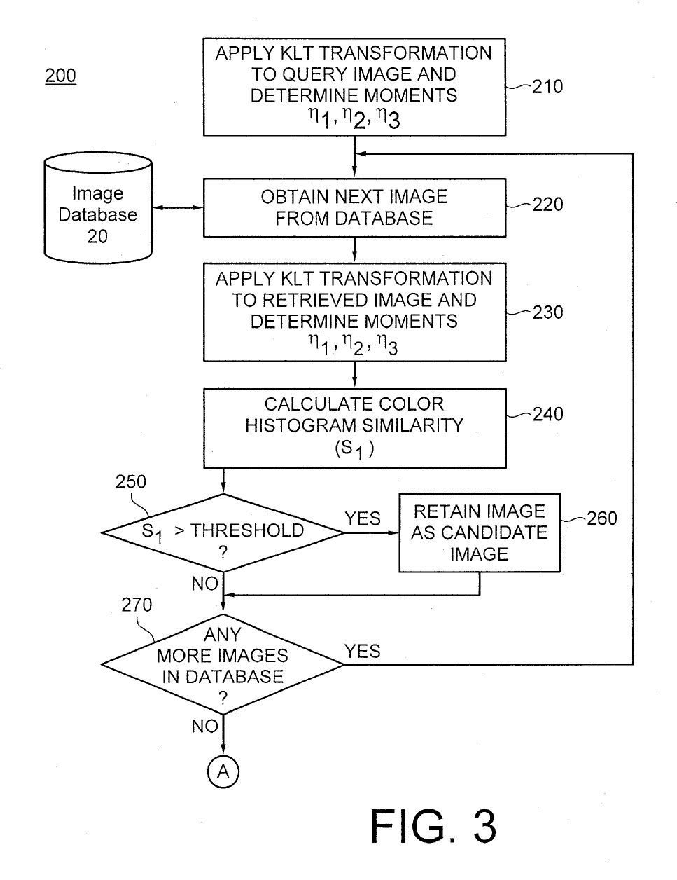

As mentioned above, the first step 100 of the retrieval process is for the user to input or select the query image. The next step 200 is to determine the most similar candidate images using a similarity metric S₁, which is determined based on the similarity of the color histogram features of the query image and each image stored in image database 20. A more detailed explanation of this step 200 will be given below with respect to FIG. 3.

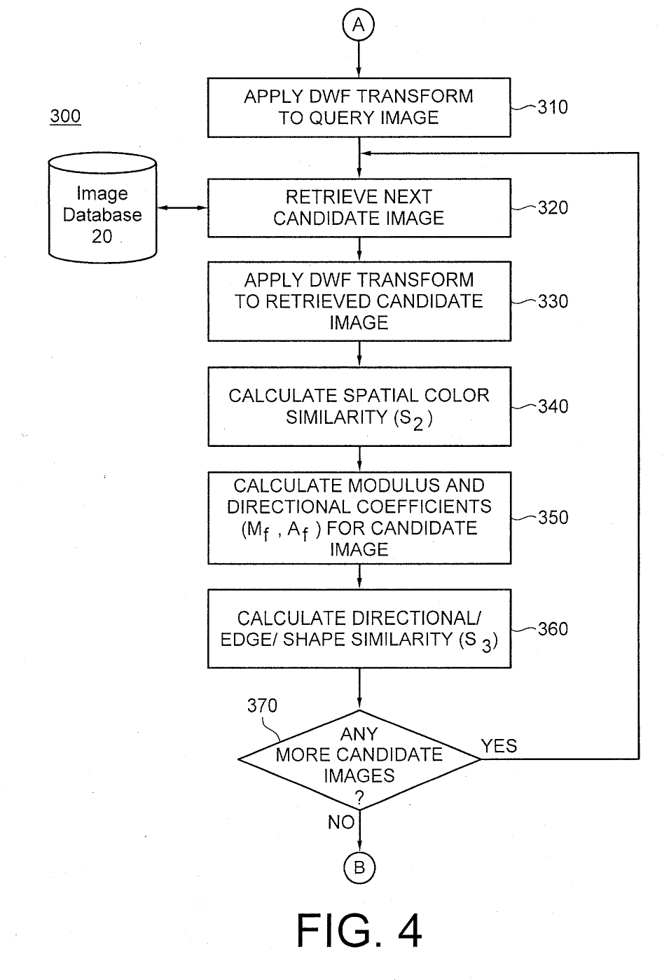

The next step 300 is to determine, from the remaining candidate images, the similarity between each of the remaining images and the query image based on their spatial-color features and their direction/edge/shape features. This step includes the calculation of a similarity metric S₂ for each candidate image based on the similarity of spatial-color features, and the calculation of a similarity metric S₃ for each image based on the similarity of direction/edge/shape features. This step 300 will be explained in more detail below in connection with FIG. 4.

In step 400 of FIG. 2, an overall similarity metric Sₒᵥₑᵣₐₗₗ is calculated for each candidate image based on the metrics S₁, S₂ and S₃ calculated for the candidate image. Accordingly, the images in the image database 20 most similar to the query image are determined in step 500, according to the overall similarity metric Sₒᵥₑᵣₐₗₗ, and retrieved from the database 20 to be output (or otherwise indicated) to the user.

FIG. 3 illustrates a series of sub-steps that are performed in order to determine the candidate images of image database 20 sufficiently similar to a query image based on color histogram features according to step 200 of FIG. 2.

As discussed above, histogram-based indexing and retrieval methods require extra storage and a large amount of processing. Meanwhile, they are sensitive to illumination changes. One way to reduce the required computation overhead is to employ the central moments of each color histogram as the dominant features of a histogram. As discussed in more detail in a paper by M. Stricker and M. Orengo entitled “Similarity of Color Images,” Proc. SPIE 2420, 381-392, San Jose, February 1995, moments can be used to represent the probability density function (PDF) of image intensities. Since the PDF of image intensities is the same as the histogram after normalization, central moments can be used as representative features of a histogram.

To achieve illumination invariant properties, the effect of illumination on the histograms should be analyzed. Usually, it can be observed that the histograms of an image under varying lighting conditions can be approximated as translated and scaled versions of each other. So, assuming that the change in illumination has dilated and translated the PDF of an image function ƒ(x) to

$${f}^{′} ( x ) = f ( \frac{x - b}{a} ) / a ,$$

the central moment Mₖ′=∫(x−\overline{x})^{k}ƒ′(x)dx of the new PDF can be expressed as Mₖ′=a·Mₖ, where Mₖ is the central moment of the PDF of ƒ(x). Therefore, a set of normalized moments that is invariant to scale a and shift b can be defined as:

$${η}_{k} = \frac{{M}_{k + 2}}{{M}_{2}} k > 2 , k ∈ Z . \qquad Eq . ( 1 )$$

In FIG. 3, the following Karhunen-Loeve Transform (KLT) is applied to the original colored query image in step 210:

$$[ \begin{matrix}{k}_{1} \\ {k}_{2} \\ {k}_{3}\end{matrix} ] = [ \begin{matrix}0.333 & 0.333 & 0.333 \\ 0.5 & 0.0 & - 0.5 \\ - 0.5 & 1.0 & - 0.5\end{matrix} ] [ \begin{matrix}R \\ G \\ B\end{matrix} ] , \qquad Eq . ( 2 )$$

where R, G, and B are luminance values for the red, green, and blue channels, respectively.

In sub-step 220 an image is retrieved from the image database 20, and the same KLT is applied to the retrieved image in sub-step 230.

The above KLT transforms an image to an orthogonal basis. Therefore, the three components generated are statistically decorrelated. It is hence quite suitable for further feature extraction on each channel histograms.

On the transformed Karhunen-Loeve space, the first, second and third illumination invariant moments η₁, η₂, η₃ given by Equation (1) are utilized as the features for each color channel. Consequently, for the first step of retrieval, 3×3=9 color features are obtained.

To measure similarity of the query image and the retrieved image, the following metric S₁ is calculated in sub-step 240:

$$\begin{matrix}{S}_{i} = \frac{1}{{D}_{i} + 1} \\ {D}_{i} = {\sum }_{j = 1}^{K} ( \frac{{f}_{i , j}^{q}}{{f}_{i , j}} + \frac{{f}_{i , j}}{{f}_{i , j}^{q}} - 2 ) ,\end{matrix} \qquad Eq . ( 3 )$$

where ƒ_{i,j}^{q} and ƒ_{i,j} are feature j of type i of the query image and the candidate image respectively, k is the total number of features, and Dᵢ is the distance of ƒᵢ^{q} and ƒᵢ.

The above similarity metric does not require the estimation of normalization constants. It compares favorably with Minkowski distance or the quadratic distance.

According to sub-steps 250 and 260, if the similarity metric Sᵢ calculated in Equation (3) is greater than a preset threshold S_{T} (S_{T} can be chosen to be approximately 0.05 in an exemplary embodiment), the corresponding image is retained as a candidate image. Otherwise, the rejected image is rejected as a dissimilar image. In sub-step 270, it is determined whether there are more images remaining in the image database 20. If there are more images, processing returns to sub-step 220 to retrieve and analyze the next image.

For this first round of retrieval illustrated in FIG. 3, we define the histogram based moment features as of type 1 (i=1). Then based on the calculated value of S₁, most of the dissimilar images are filtered out during the first round. This filtering helps eliminate unnecessary processing in the second round and thereby reduces computation overhead.

FIG. 4 illustrates a second round of feature extraction and filtering that is performed on the remaining query candidates. Specifically, FIG. 4 is a flowchart showing the sub-steps performed in step 300 of FIG. 2, for determining the similarity of the remaining candidate images to the query image based on spatial-color and direction/edge/shape features. A wavelet-based method is applied to the candidate images in order to obtain a good set of representative features for characterizing and interpreting the original signal information.

While Discrete Wavelet Transform (DWT) inherently has the property of optimal spatial-frequency localization, this known wavelet-based method is not translation invariant due to its down sampling. Also, DWT is not rotation invariant. Accordingly, in an exemplary embodiment of the present invention, multi-resolution Wavelet Frame (WF) decomposition without downsampling is applied to the original images of the remaining candidates to obtain robustness against translation and rotation. WF decomposition may be applied as follows:

Suppose that the Fourier Transform ψ(ω) of wavelet function ψ(x) satisfies:

$$\begin{matrix}\begin{matrix}\int \frac{{\vert ψ ( ω ) \vert}^{2}}{\vert ω \vert} ⅆ ω < ∞ \\ and\end{matrix} & \\ A \leq {\sum }_{j = - ∞}^{+ ∞} {\vert ψ ( {2}^{j} ω ) \vert}^{2} \leq B , & Eq . ( 4 )\end{matrix}$$

where A>0 and B>0 are two constants. If ξ(x) denotes the dual wavelet of ψ(x), and φ(x) denotes the scaling function whose Fourier transform satisfies:

$${\vert ϕ ( ω ) \vert}^{2} = {\sum }_{j = 1}^{∞} ψ ( {2}^{j} ω ) ξ ( {2}^{j} ω ) . \qquad Eq . ( 5 )$$

Then the low-pass filter h(n) and high pass filter g(n) of the Dyadic Wavelet Frame (DWF) decomposition can be derived according to the following functions:

φ(2ω)=e^{-jβ}^{₁}^{ω}H(ω)φ(ω)

ψ(2\overline{ω})=e^{-jβ}^{₂}^{ω}G(ω)φ(ω). Eq. (6)

In Equation (6), H(ω) and G(ω) are the Fourier transforms of h(n) and g(n) respectively. 0≦β₁<1 is a sampling shift, 0≦β₂<1 is another sampling shift.

Let S₂_{⁰}ƒ be the finest resolution view and S₂_{^{j}}ƒ be the coarsest resolution view of image function ƒ(m,n)(mε[0,M−1] and nε[0,N−1], where M×N is the image size), W₂_{^{j}}¹ƒ be the high pass view at level j of ƒ(m,n) along the X direction, W₂_{^{j}}²ƒ be the high-pass view at level j of ƒ(m,n) along the Y direction. Assume h₂_{^{j}}(n) and g₂_{^{j}}(n) denote the discrete filters obtained by putting 2^{j}−1 zeros between each pair of consecutive coefficients of h(n) and g(n), respectively. The two dimensional DWF transform algorithm can then be illustrated as follows:

S₂_{⁰}ƒ(m,n)=ƒ(m,n); j=0;

while j<J do

$$\begin{matrix}{W}_{{2}^{j + 1}}^{1} f ( m , n ) = {S}_{{2}^{j}} f ( m , n ) \cdot [ {g}_{{2}^{j}} ( m ) , d ( n ) ] ; \\ {W}_{{2}^{j + 1}}^{2} f ( m , n ) = {S}_{{2}^{j}} f ( m , n ) \cdot [ d ( m ) , {g}_{{2}^{j}} ( n ) ] ; \\ {S}_{{2}^{j + 1}} f ( m , n ) = {S}_{{2}^{j}} f ( m , n ) \cdot [ {h}_{{2}^{j}} ( m ) , {h}_{{2}^{j}} ( n ) ] \\ if j = J - 1 do end ; \\ {S}_{{2}^{j + 1}} f ( m , n ) = {S}_{{2}^{j + 1}} f ( m , n ) {↓}_{{2}^{j + 1}}\end{matrix}$$

endif;

j=j+1;

In the above annotation,

$${↓}_{{2}^{j + 1}}$$

represents down sampling by replacing each 2^{j+1}×2^{j+1} non-overlapping block with its average value. d(n) is the Dirac filter whose impulse response is equal to 1 at n=0 and 0 otherwise.

With the above multi-resolution WF decomposition, we obtain a sub-sampled low-pass image of

$$\frac{1}{{2}^{J}}$$

original size and a set of X-Y directional high-pass images for each color channel of the original sized image. Consequently, if the size of the original images is 128×128 pixels, and 5 levels of WF decompositions are performed (J=5), the low-pass subimage is down-sampled to size 4×4 and 10 X-Y directional subimages of size 128×128 pixels are obtained.

The above DWF transform is first applied to the query image in sub-step 310 of FIG. 4. Next, in sub-step 320, one of the remaining candidate images is retrieved from image database 20. In an alternative embodiment, the candidate images obtained from step 200 of FIG. 2 may be stored in another storage medium, such as memory 14, for quicker access. The DWF transform is then applied to the retrieved candidate image in sub-step 330.

In sub-step 340, a similarity metric S₂ is determined according to the similarity in spatial-color features of the candidate image and the query image. To extract the spatial-color information, each low-pass subimage coefficient is mean-subtracted (to obtain illumination invariance) and normalized to obtain the spatial-color distribution features S₂_{^{J}} as follows:

$$\begin{matrix}{S}_{{2}^{J}} ( n * M + m + 1 ) = \frac{{S}_{{2}^{J}} ( m , n ) - {\overline{S}}_{{2}^{J}} ( m , n )}{\sqrt{( {\sum }_{n = 0}^{N - 1} {\sum }_{m = 0}^{M - 1} {( {S}_{{2}^{J}} ( m , n ) - {\overline{S}}_{{2}^{J}} ( m , n ) )}^{2} ) / MN}} , \\ where & Eq . ( 7 ) \\ {\overline{S}}_{{2}^{J}} ( m , n ) = {\sum }_{n = 0}^{N - 1} {\sum }_{m = 0}^{M - 1} {S}_{{2}^{J}} ( m , n ) / MN . & \end{matrix}$$

By this method, 3×(4×4)=48 spatial-color features are further obtained. The value of S₂ is then calculated according to Equation (3), in which the spatial-color distribution features are defined as type i=2.

For the X-Y directional subimages at each decomposition level, the following modulus and directional coefficients are calculated in sub-step 350:

$$\begin{matrix}M {f}_{{2}^{j}} ( x , y ) = \sqrt{{W}_{{2}^{j}}^{1} {f ( x , y )}^{2} + {W}_{{2}^{j}}^{2} {f ( x , y )}^{2}} \\ A {f}_{{2}^{j}} ( x , y ) = ⌊ a r g tan ( \frac{{W}_{{2}^{j}}^{1} f ( x , y )}{{W}_{{2}^{j}}^{2} f ( x , y )} ) ⌋\end{matrix} , \qquad Eq . ( 8 )$$

where └x┘ denotes truncating a valuex to an integer. Thereby the obtained directional coefficients Aƒ comprise a set of integers of the range [−180,180).

To keep only the dominant direction/edge/shape information, the high-pass coefficients whose modulus coefficients Mƒ are below a preset threshold are filtered out. In an exemplary embodiment, the mean of modulus coefficients Mƒ of each high-pass coefficient is set as the preset threshold to execute such filtering.

On the remaining high-pass coefficients with significant magnitudes, a series of TRSI direction/edge/shape features are derived from the histogram of the Aƒ at each decomposition level. The direction/edge/shape features we employed is again the central moments of order 2, 3 and 4, respectively as follows:

$$\begin{matrix}{M}_{2} = {( \frac{1}{N} {\sum }_{j = 1}^{N} {( {P}_{ij} - {E}_{i} )}^{2} )}^{1 / 2} \\ {M}_{3} = {( \frac{1}{N} {\sum }_{j = 1}^{N} {( {P}_{ij} - {E}_{i} )}^{3} )}^{1 / 3} . \\ {M}_{4} = {( \frac{1}{N} {\sum }_{j = 1}^{N} {( {P}_{ij} - {E}_{i} )}^{4} )}^{1 / 4}\end{matrix} \qquad Eq . ( 9 )$$

As can be proven, the above feature is TRSI. Therefore, on the X-Y directional subimages, 3×(5×3)=45 TRSI features are obtained.

In sub-step 360, the feature similarity metric S₃ is calculated according to equation (3), in which direction/edge/shape features as of type i=3. In sub-step 370, it is determined whether any more candidate images remain. If so, processing loops back to sub-step 320 to determine S₂ and S₃ for the next image.

The overall feature similarity metric of step 400 in FIG. 2 is calculated according to the following formula:

$${S}_{overall} = \frac{{w}_{1} {S}_{1}^{2} + {w}_{2} {S}_{2}^{2} + {w}_{3} {S}_{3}^{2}}{{S}_{1} + {S}_{2} + {S}_{3}} , \qquad Eq . ( 10 )$$

where w₁, w₂, w₃ε[0,1] are the suitable weighting factors of S₁, S₂ and S₃, respectively. (exemplary values have been determined to be w₁, w₃=1 and w₂=0.8). However, w₁, w₂, w₃ can be further fine-tuned heuristically to yield the optimal retrieval results when the database becomes quite large.

In an exemplary embodiment, similar to the first round of retrieval, images whose Sₒᵥₑᵣₐₗₗ is less than a threshold S_{T} are filtered out as dissimilar images. Alternatively, the image retrieval system 5 may be configured to retain the R most similar images, where R≧1 (for example, the system may be configured to retain the ten most similar images). The retained images are retrieved and output as the final retrieval results, and may be ranked according to Sₒᵥₑᵣₐₗₗ.

In a further exemplary embodiment, the sets of color, spatial-color, and direction/edge/shape features determined according to the KLT transform and DWF decomposition may be pre-calculated and stored in correspondence to each image, before any query is performed. Accordingly, the processing speed for retrieving images from image database 20 can be significantly increased, since these features will not be calculated during the retrieval process. In this embodiment, the image features may either be stored in the image database 20 in connection with the image. Alternatively, the features may be stored in a separate image features database within the external storage device 90 or within the memory 14 of the image similarity processing device 10.

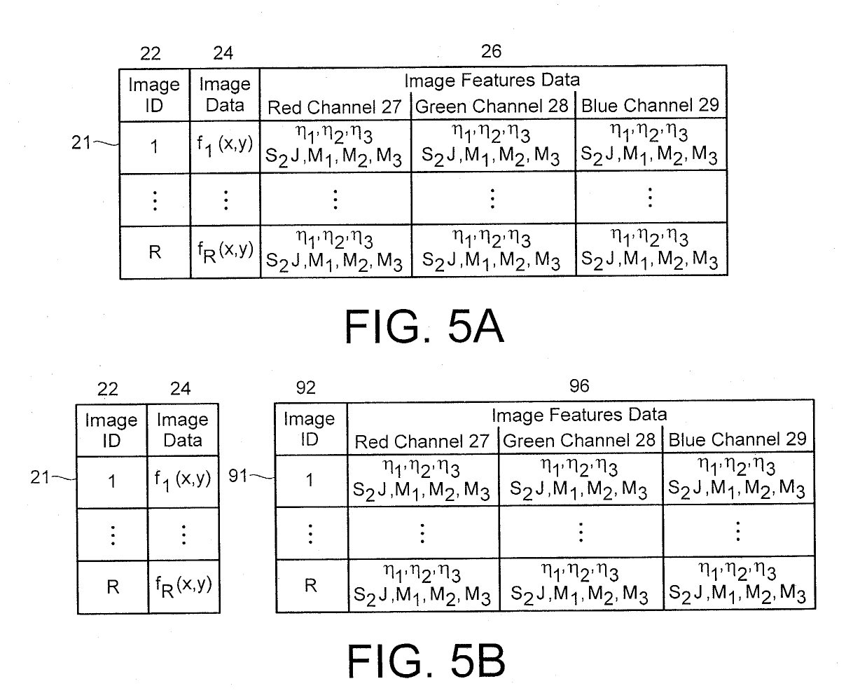

FIG. 5A illustrates a set of records 21 of an image database 20 according to the exemplary embodiment where image features are determined and stored in the image database 20 before an image query is submitted. Each record includes an image identifier in field 22 and the actual image data in field 24, i.e., the image function ƒ (x,y). Further included in each image record are the feature parameters for the red channel in field 27, the parameters for the green channel in field 28 and the parameters for the blue channel in field 29. These feature parameters may include the calculated moments η₁, η₂, η₃ of the color histograms, the low-pass image coefficients S₂_{^{J}}, and the central moments M₂, M₃, and M₄.

FIG. 5B illustrates a set of records 21 of image database 20 and a set of records 91 of a separate image features database in the exemplary embodiment where image features are determined and stored in the image features database before an image query is submitted. Similar to the embodiment of FIG. 5A, each record in the image database 20 includes an image identifier in field 22 and the image data in field 24. Each record of the set of records 91 stored in the image features database includes the image identifier in field 92. Each record of the image features database further includes the feature parameters for the red channel in field 97, the parameters for the green channel in field 98 and the parameters for the blue channel in field 99.

As can be seen from the above description, one superior advantage of the present invention is its illumination invariance and robustness against translation, rotation and scaling changes while taking such features as color, spatial, detailed direction distribution information into integrated account. Since actual images/video frames are usually captured under different illumination conditions and with different kinds of geometric distortions, the proposed approach is quite appealing for real-time on line image/video database retrieval/indexing applications.

Although the present invention is mainly targeted at automatic image retrieval, it can also be effectively applied for video shot transition detection and key frame extraction, as well as further video indexing and retrieval. This is because the essential and common point of these applications is pattern matching and classification according to feature similarity.

The novelty of the present invention lies in several characteristics. First of all, a new set of illumination invariant histogram-based color features on the orthogonal Karhunen-Loeve space is effectively combined with other spatial/direction/edge/shape information to obtain an integrated feature representation. Secondly, shift invariant Wavelet Frame decompositions and the corresponding initiative TRSI feature extractions are proposed to obtain illumination and TRS invariance. This unique advantage is critical to the success of the invention. It cannot be achieved with the conventional discrete wavelet transform based methods. Thirdly, a novel similarity matching metric is proposed. This metric requires no normalization and it yields proper combination or emphasis of different feature similarities. Finally, the whole retrieval process is progressive. Since the first step of retrieval has filtered out most of the dissimilar images, unnecessary processing is avoided and retrieval efficiency is increased.

The present invention, as described above, sets forth several specific parameters. However, the present invention should not be construed as being limited to these parameters. Such parameters could be easily modified in real applications so as to adapt to retrieval or indexing in different large image/video databases.

In addition, the image retrieval method of the present invention should not be construed as being limited to the specific steps described in the embodiment above. Many modifications may be made to the number and sequence of steps without departing from the spirit and scope of the invention, as will be contemplated by those of ordinary skill in the art.

For instance, in another exemplary embodiment of the present invention, efficiency of the image retrieval process may be enhanced by first using the feature of overall variance of each image to filter out the most dissimilar images in the image database 20. In subsequent steps, features derived from the color histogram moments and low-pass coefficients at the coarsest resolution may be used to further filter out dissimilar images from a remaining set of candidate images. Then, the directional/edge/shape features for the remaining candidate images may be determined, and an overall similarity metric may be used to rank these remaining images based on the color histogram, spatial-color, and direction/edge/shape feature sets. This alternative embodiment can further reduce unnecessary processing at each retrieval step.

The invention being thus described, it will be obvious that the same may be varied in many ways. Such variations are not to be regarded as a departure from the spirit and scope of the invention, and all such modifications as would be obvious to one skilled in the art are intended to be included with the scope of the following claims.

What is claimed is:

1. An image processing system comprising:
an input device for designating a query image;
an image database comprising one or more images; and
an image similarity processing device for determining a set of features for each image in said image database and for said query image, said set of features including image features that are insensitive to illumination variations and image features that are insensitive to variations in translation, rotation, and scale, and assigning a similarity value to each image in said image database indicating a similarity between said determined set of features for said assigned image and said determined set of features for said query image.

2. The system of claim 1, wherein said image features of an image that are insensitive to illumination and geometric (translation, rotation and scale) variations are determined by applying a wavelet transform to a corresponding image.

3. The system of claim 2, wherein said image features that are insensitive to illumination and geometric variations include at least one central moment calculated from high pass coefficients and several low pass coefficient features obtained from said applied wavelet transform.

4. The system of claim 1, wherein said image features that are insensitive to variations in illumination, translation, rotation, and scale are determined by applying a Karhunen-Loeve Transform (KLT) on a corresponding image.

5. The system of claim 4, wherein said image features that are insensitive to variations in illumination, translation, rotation, and scale include at least one normalized moment calculated from a color histogram obtained from said applied KLT transform.

6. The system of claim 1, further comprising:
an output device for outputting images retrieved from said image database by said image similarity processing device based on said assigned similarity value.

7. The system of claim 4, wherein said retrieved images are ranked according to assigned similarity value.

8. The system of claim 1, wherein said set of features is determined and stored in association with its corresponding image before a query image is designated using said input device.

9. A method of processing images comprising:
designating a query image;
determining a set of features for each image in an image database and for said query image, said set of features including image features that are insensitive to illumination variations and image features that are insensitive to variations in translation, rotation, and scale; and
assigning a similarity value to each image in said image database indicating a similarity between said determined set of features of said assigned image and said determined set of features for said query image.

10. A computer-readable medium comprising a set of instructions executable by a computer system including an image database, said computer-readable medium comprising:
instructions for designating a query image;
instructions for determining a set of features for each image in said image database and for said query image, said set of features including image features that are insensitive to illumination variations and image features that are insensitive to variations in translation, rotation, and scale; and
instructions for assigning a similarity value to each image in said image database indicating a similarity between said determined set of features of said assigned image and said determined set of features for said query image.
